(19) United States
(12) Patent Application Publication
(10) Pub. No.: US 2010/0100459 A1
(43) Pub. Date: Apr. 22, 2010

(54) REAL ESTATE BROKERAGE METHOD THROUGH A VIDEO-CONFERENCE

(76) Inventor: Hyun Kyun Cho, Seoul (KR)

Correspondence Address: SHERR & VAUGHN, PLLC, 620 HERNDON PARKWAY, SUITE 320, HERNDON, VA, 20170, US

(21) Appl. No.: 12/627,180

(22) Filed: Nov. 30, 2009

Related U.S. Application Data
(63) Continuation of application No. 11/146,046, filed on Jun. 7, 2005, now abandoned.
Application No. 11/146,046 is a continuation-in-part of application No. PCT/KR2003/002680, filed on Dec. 6, 2003.

(30) Foreign Application Priority Data
Jul. 12, 2002 (KR) 10-2002-0077617

(51) Int. Cl. H04N 7/15; G06Q 30/00; G06Q 50/00; G06F 17/30

(52) U.S. Cl. 705/27; 348/14.08; 348/E07.084; 707/802; 707/E17.044

(57) ABSTRACT

In a real estate brokerage method through a video-conference (VDC), a purchaser and a broker meet with each other through an on-line VDC. This method includes steps for providing a article search page to a communication terminal of a non-member that connects with a corresponding Internet site; entering identification information of the non-member and search condition information thereof into the article search page; and providing an article describing page having information of one or more articles satisfying the search condition to the communication terminal of the non-member. In case that the non-member requests an on-line VDC, the request is offered to a corresponding article register. After the article register checks information of a non-member who requested VDC, the article register can select a VDC execution button included in a page having buttons to determine whether VDC should be executed or not.

This application is a Continuation-In-Part of PCT International Application No. PCT/KR2003/002680 filed on Dec. 6, 2003, which designated the United States.

### FIELD OF THE INVENTION

The present invention relates to a real estate brokerage method through the Internet, more particularly to a real estate brokerage method using a video-conference which enables a purchaser to have a video conference (VDC) with a broker through the Internet.

### BACKGROUND OF THE INVENTION

In a conventional real estate transaction method, when an owner of an article or a requester for an article decides conditions such as kinds of brokerage (sale or lease) and price, etc., thereof and then requests a broker to find articles satisfying such conditions, the broker mediates transactions by putting the information about the requested article on a public board or by providing it to clients who visit in person. In another conventional real estate transaction method employing the Internet, once an article registered on a web site which provides article information, a purchaser who has found the registered article must give a phone call to check up individually to the register to get more concrete information. However since searching through the Internet and confirming the information about an article have limitations of the information accuracy, it still remains cumbersome that a purchaser should visit a broker in person to check out or acknowledge the article.

### SUMMARY OF THE INVENTION

It is, therefore, an object of the present invention to provide a real estate brokerage method through a video conference which can make a real time conference for an article between a purchaser (who wants to buy the article) and a selling broker on the Internet.

To achieve the object of the present invention, in accordance with a preferred embodiment of the present invention, there is provided a real estate brokerage method through a video conference (VDC) for use in a real estate brokerage system connected to user's terminals through the

Internet, the method including the steps of; a) providing an article search page to a terminal of a non-member accessed to a corresponding Internet site through the Internet; b) generating, in case that identification information of a user and search condition data are entered into a user data entry window and a search condition data entry window included in the article search page, respectively, an article describing page having information about an article satisfying the search condition to thereby provide the article describing page to the non-member's terminal; c) producing, in case that a VDC request button included in the article describing page is clicked through the non-member's terminal, VDC requester information register page (hereinafter referred to as “register page”) to thereby provide the register page to the non-member's terminal; d) generating, in case that VDC requester information is entered into requester information entry window included in the register page through the non-member's terminal, VDC request occurrence particular page (hereinafter referred to as “particular page”) based on the VDC requester information and the article information to thereby provide the particular page to an article registrant's terminal; e) providing, in case that an acknowledgment (ACK) button included in the particular page is clicked through the article registrant's terminal, a VDC requester information acknowledgement (ACK) and VDC execution or non-execution determination page (hereinafter referred to as “determination page”) to the article registrant's terminal;

f) offering, in case that a VDC requester information ACK button included in the determination page is clicked through the article registrant's terminal, a VDC requester information page having information about the VDC requester to the article registrant's terminal; and g) generating, in case that a VDC closing button is selected through the article registrant's terminal, VDC result processing page to thereby provide the VDC result processing page to the article registrant's terminal.

In accordance with another preferred embodiment of the present invention, the method described in the above may further include the steps of:

h) activating, in case that a VDC reject button included in the determination page is selected through the article registrant's terminal, a reject reason entry window in a preset position within the determination page; and

i) providing, in case that a sending button of the reject reason entry window is selected after reject reason is entered into the reject reason entry window thereof through the article registrant's terminal, a VDC request result page to the non-member's terminal.

### BRIEF DESCRIPTION OF THE DRAWINGS

The above and other objects and features of the present invention will become apparent from the following description of preferred embodiments given in conjunction with the accompanying drawings, in which:

FIG. 1 is an illustration of an example of a real estate brokerage system for use in achieving a real estate brokerage method through a video-conference in accordance with a preferred embodiment of the present invention;

FIG. 2 is a flow chart for describing a process of a real estate brokerage method through a video-conference in accordance with a preferred embodiment of the present invention; and

FIGS. 3 to 20 are view pages for describing real estate brokerage methods through a video-conference in accordance with preferred embodiments of the present invention.

### DETAILED DESCRIPTION OF THE PREFERRED EMBODIMENT

Hereinafter, the preferred embodiments of the present invention will be described in detail referring to the accompanying drawings.

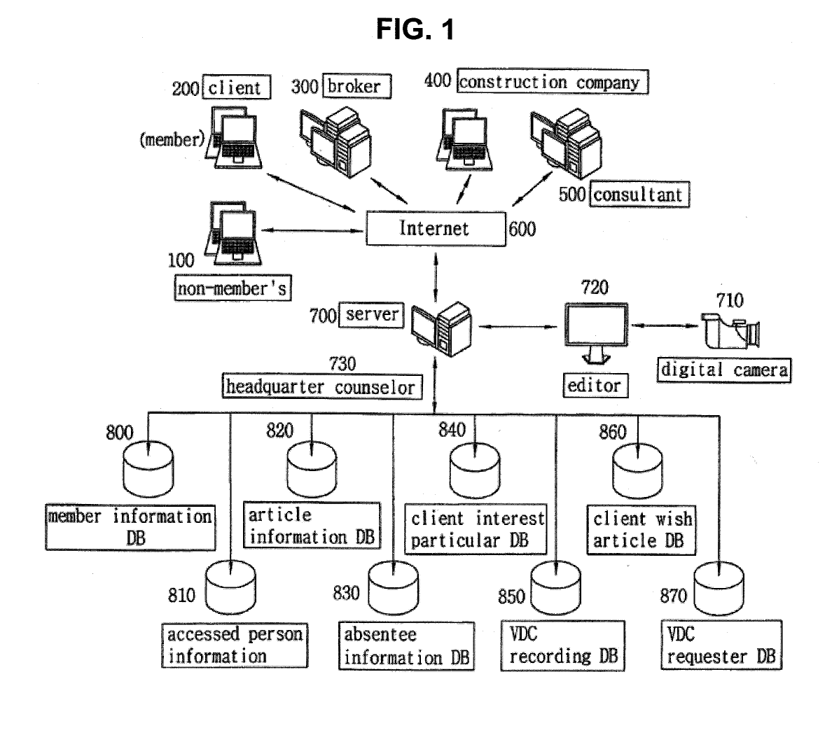

FIG. 1 is an illustration of an example of a real estate brokerage system for use in achieving a real estate brokerage method through a video-conference (VDC) in accordance with a preferred embodiment of the present invention.

Referring to FIG. 1, communication in the system is achieved through the Internet 600. Preferably, the system includes server 700 and a number of DB's 800-870. The server 700 searches article information stored in an article information DB 820 in accordance with conditions, for example at least one of kind, area, price and scale of an article which many and unspecified general user 100 (or a non-member) logging-in through the Internet 600 entered into through their own terminal, respectively. Then, the server 700 can provide corresponding article information. A client 200, a broker 300, a construction company 400, a consultant 500 can be accessed (connected) to the system through the Internet 600.

Hereinafter, although over the following entire specification, a general user (non-member) 100, the client 200, the broker 300, the construction company 400, the consultant 500 can represent the people themselves, it should be noted that they can also used (contextually) as the representation of the corresponding (user's) communication terminal (PC, PDA, Mobile phone etc.).

The plurality of DB's 800-870 include preferably a member information DB 800, an accessed person information DB 810, an article information DB 820, an absentee information DB 830, a client interest particular DB 840, a VDC recording DB 850, a client wish article DB 860 and a VDC requester DB 870.

The member information DB 800 stores the information about the member of a corresponding Internet site. The accessed person information DB 810 stores the information about the member (the one who is identified with member ID and Pass Word) or the general user (non-member) who accessed to the corresponding Internet site. The article information DB 820 stores the information about the article that the member entered. It should be noted that the article information may be made by capturing image of the article with a camera 710 and then editing the image through the editor 720.

The absentee information DB 830 stores information for absentee's. Based on the absentee information, when VDC is requested, a call or notification can be sent to a corresponding (user's) communication terminal (e.g., a mobile phone or PDA) of an absentee. Further, By using the absentee information DB 830, for the member who doesn't contact with his (or her) personal (mobile telecommunication) terminal, the information of date and time, object, participants and related article information of a VDC can be stored and then the absentee can acknowledge or check out occurred task during his or her absence when the absentee logging-in the corresponding internet site.

The client interest particular DB 840 stores information about an interest article that a client searches and information for a playback location (e.g., a living room, a bedroom, etc.), frequency or time of parts that a client was interested in during VDC. The client interest particular DB 840 also stores data required to a member's checking for analysis of client's request particulars or changing trend.

The VDC recording DB 850 stores contents of VDC when having VDC. The client wish article DB 860 stores condition data (e.g., kind, area, price and scale etc., of an article) if there is an article the client 200 wants. The information registered on the client wish article DB 860 is announced publicly to a member, e.g., the broker 300 and/or the client 200. In case that the member checks out whether he (or she) has a corresponding article or not, if he (or she) does, the broker 300 or the client 500 can register the corresponding information. Then, after a designated period (time interval needed to check out and register the information) is over, a headquarter counselor 730 of the corresponding Internet site can mediate between a member who wants the wish article and one who holds the corresponding (wish) article.

The article information is stored in the article information DB 820, wherein preferably, the article information may be stored therein after classifying processing; namely, before storage, the article information is divided into fundamental information and captured image information and the fundamental information is classified into basic information and the information for VDC. In addition, the basic information may include kind, area, price, scale of an article. The information for VDC may be classified into Internet connection target information and mobile communication connection information.

The Internet connection target information may include Internet related information (e.g., Password (ID), (Internet) address) of the target persons (e.g. a broker in charge, a consultant, an article owner, a person in charge of the corresponding internet site) of VDC. The mobile telecommunication connection information may include mobile telecommunication related information (for example, the number of the personal mobile telecommunication terminal (e.g., mobile phone or PDA)) of the target persons (e.g. a broker in charge, a consultant, an article owner, a person in charge of the corresponding internet site) for VDC.

The captured image information can be obtained by filming images for interior and/or exterior view of the article in moving images or still images (pictures) and then editing the filmed image of the article and dividing the edited image by the state, for example, into the case of clear shaped article (e.g., apartment, store, complex building) and into the case of hardly recognizing shaped article (e.g., forest and land).

For example, in case of clear shaped article (e.g., apartment, store, complex building), the digital camera 710 films the article by the location (e.g. bedroom, kitchen, living room, bathroom, etc.) for more exact and detail understanding of the contents of the article and generates image information by marking the commodity information (e.g., commodity catalogue, pictures, option) of the goods which are installed in the article case by case on the article image. Further, the editor 720 may provide a (two dimensional) cross sectional view of the article as changed information in the form of three-dimensional (3D) to thereby give 3D-view effect to the structure and help a client with estimation of the article by offering information about (convenient) facilities (e.g., school, subway, etc.) around the article.

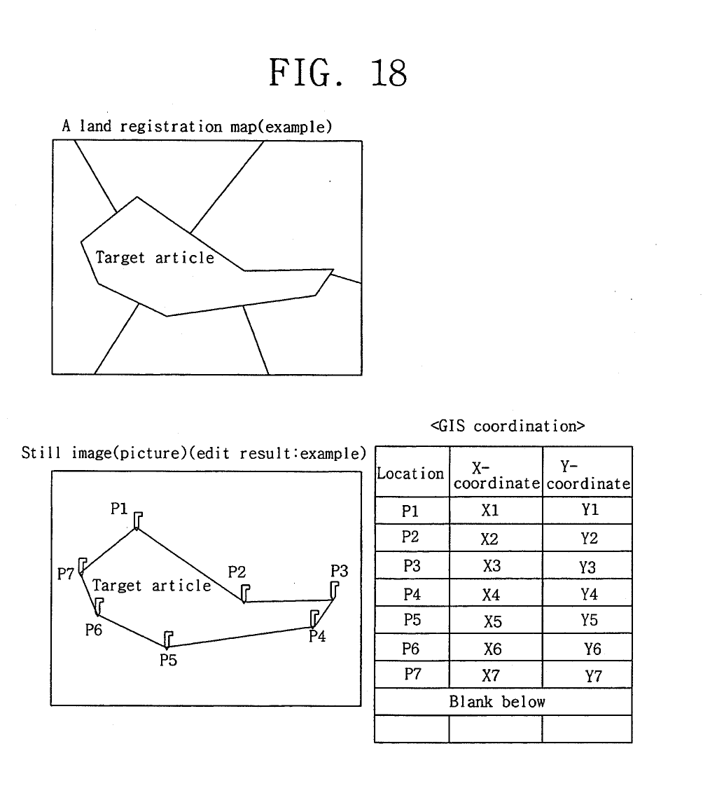

Alternatively, for unclear shaped article (e.g., forest/land, a land as shown in FIG. 18), the editor 720 may indicate the shape and the correct location (coordinates) of the article by using a land registration map, geographical information system (GIS) and edit it to make the shape of the article clear and may build the location (coordinates) information on the article information DB 820 as reference materials by making it into a chart.

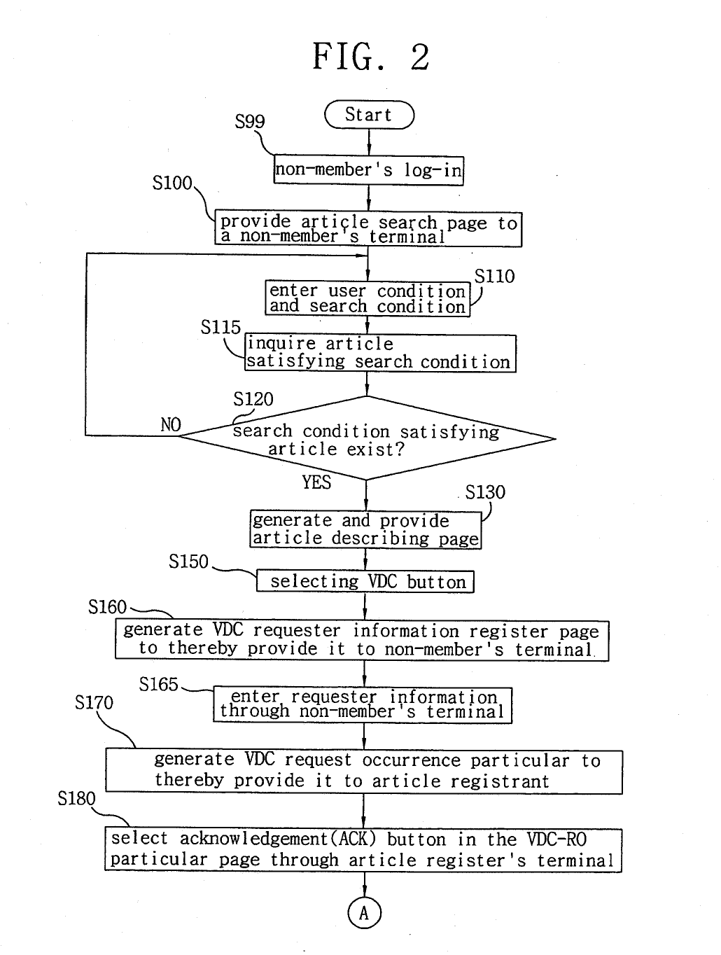

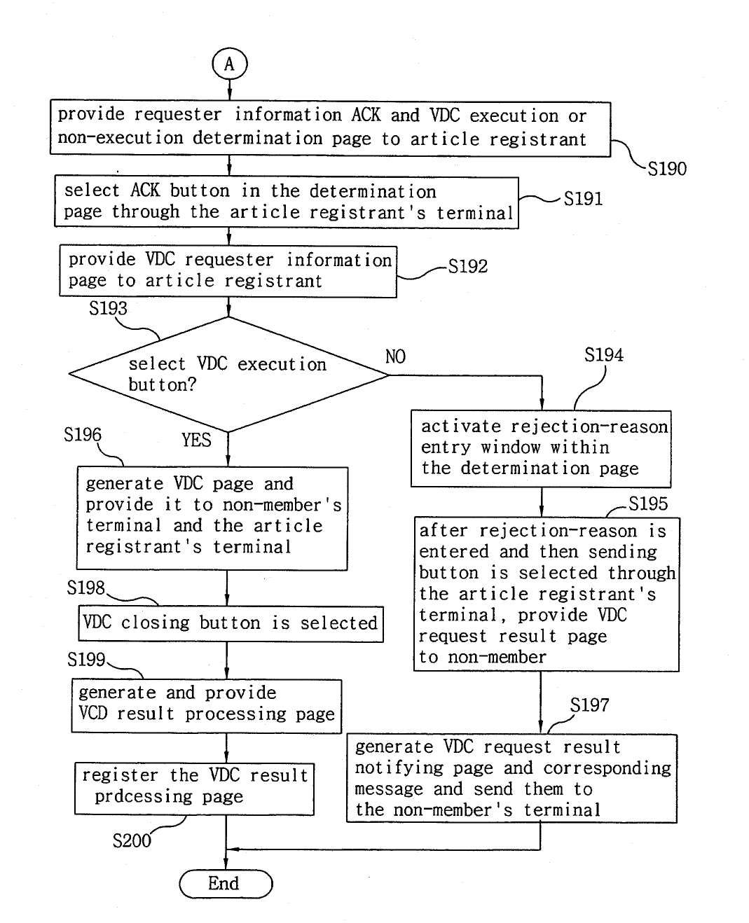

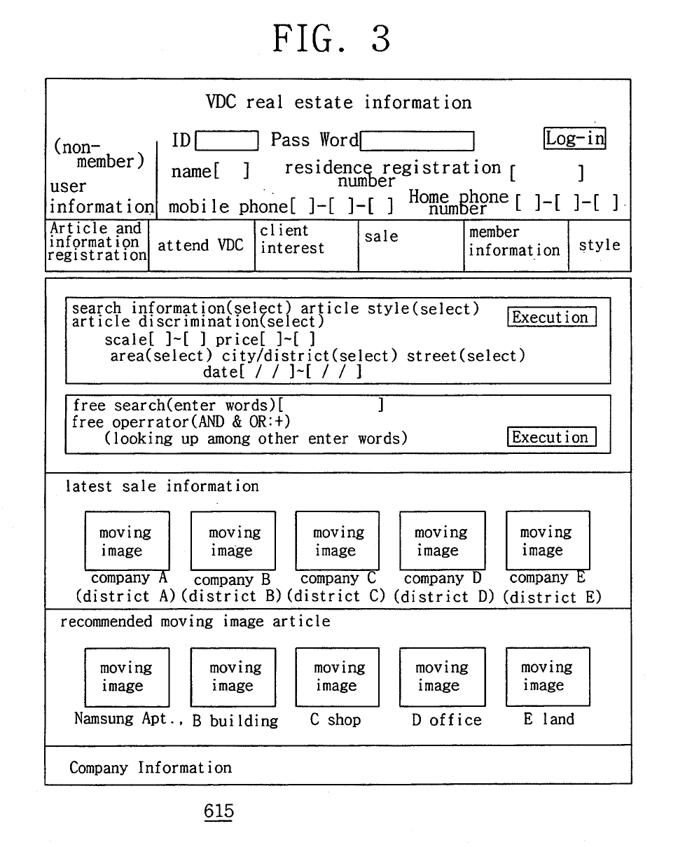

FIG. 2 is a flow chart for describing a process of a real estate brokerage method through a video-conference (VDC) in accordance with a preferred embodiment of the present invention. Referring to FIG. 2, in case that the non-member (100: the general user) logs-in to the corresponding internet site through the Internet 600 (at step S99). Then, the server 700 may generate initial page i.e. an article search page 615, as shown in FIG. 3 for searching an article and provides the article search page 615 to the non-member's terminal (100: hereinafter, omitting “terminal”, only “non -member” can mean the same) (at step S100).

The article search page 615 may include a user data entry window and a search condition data entry window. After the non-member 100 enters user information (e.g., name, ID number, wired telephone number, a mobile telecommunication terminal (mobile phone or PDA etc.) number) into the user data entry window and enters search condition (kind, area, price and scale etc. of the article) (data) into the search condition data entry window, if the non-member 100 selects an execution button included in the article search page 615, then the user information and the search condition data which were entered into the article search page 615 are offered to the server 700 (at step S110).

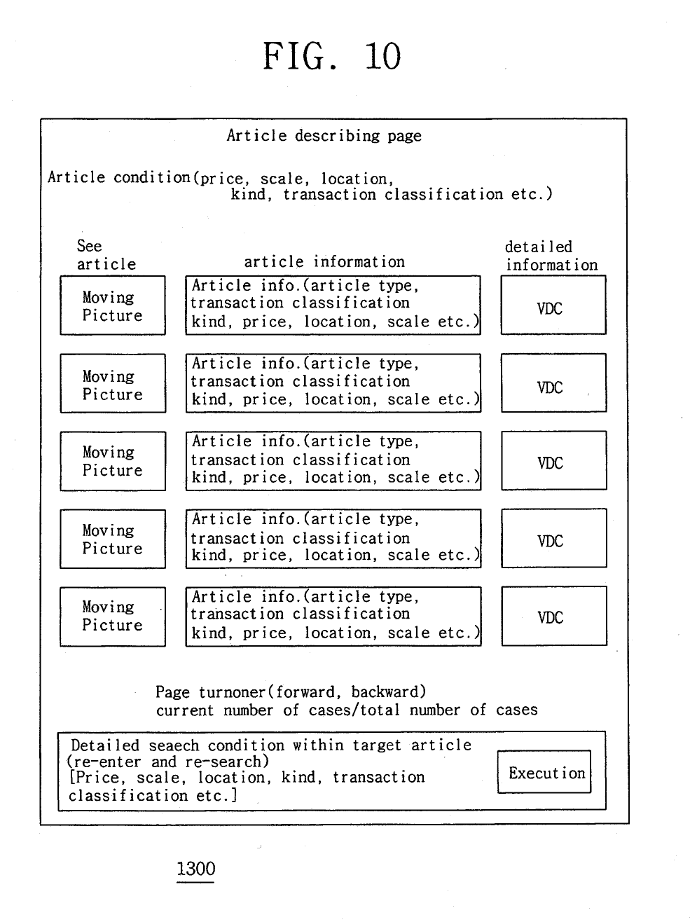

If the user information and the search condition data (e.g., kind, area, price of an article) are entered into, the server 700 inquires an article satisfying the search condition (data) with respect to the article information stored in the article information DB 820 (at step S115). In case that there is at least one article satisfying the search condition, the server 700, by using the article information DB 820, generates an article describing page 1300 (as shown in FIG. 10) having information about an article satisfying the search condition and then provides the article describing page to the non-member 100 (at steps S120 and S130). The article describing page 1300 may have at least one of moving picture information, article information and VDC button for each of one or more articles. If there is no article satisfying the search condition doesn't exist (e.g., at step S120), the process may return to step S110.

Seeing the article information shown in the article describing page 1300, the non-member 100 can select the VDC button if he (or she) wants to get more detailed information thereof (at step S150).

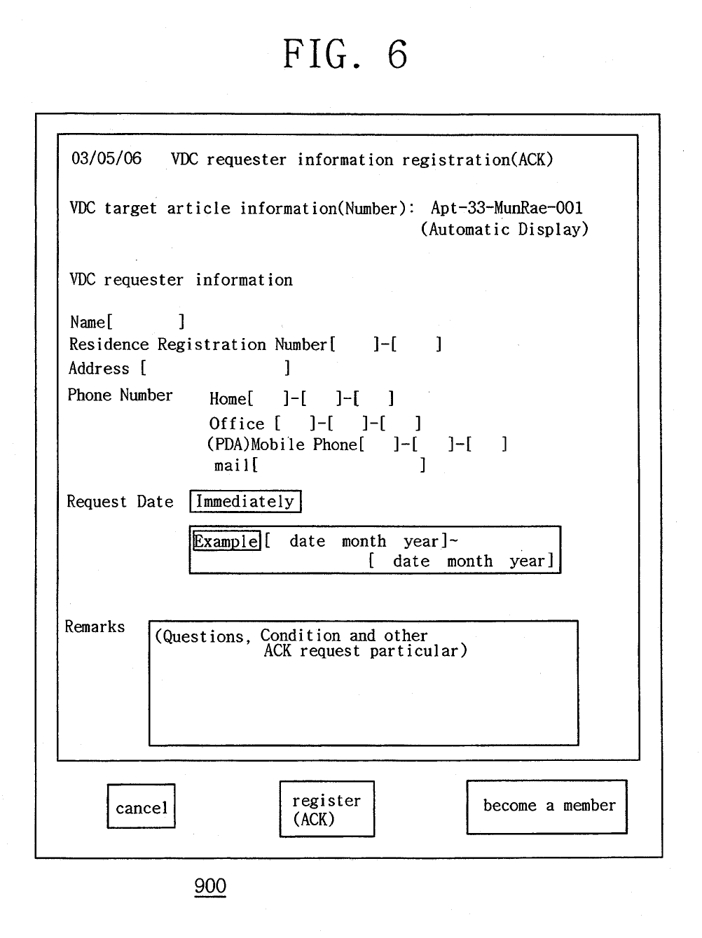

In case that the non-member 100 selects the VDC button, the server 700 produces VDC requester information register page 900 as shown in FIG. 6 to thereby provide the VDC requester information register page 900 to the non-member (i.e., non-member's terminal) 100 (at step S160). Next, at step S165, VDC requester information may be registered through the non-member's terminal.

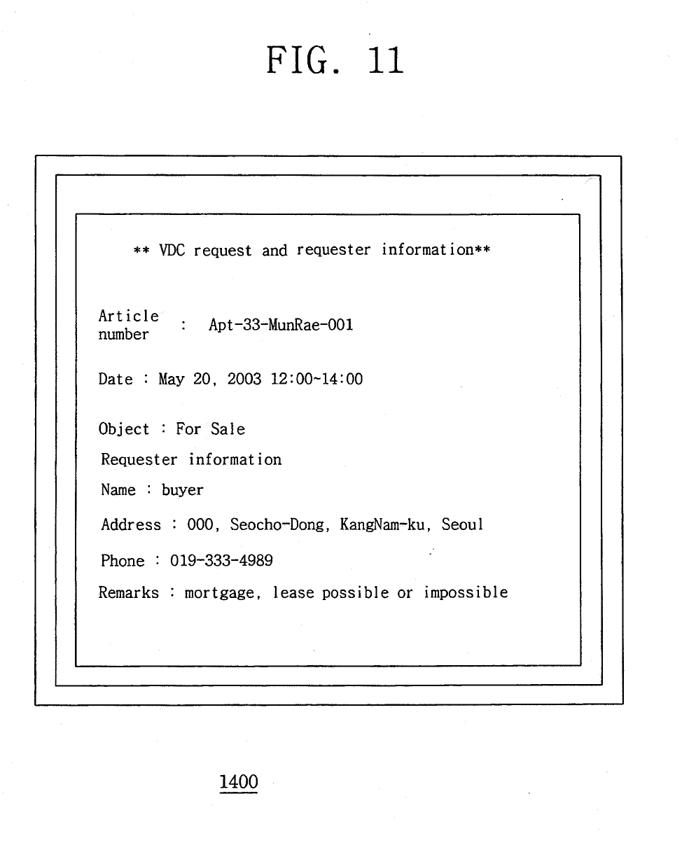

In case that the non-member 100 enters requester information into the requester information entry window of the VDC requester information register page 900 (at step S165) and selects (clicks) acknowledgement (“ACK”) button of the VDC requester information register page 900, the entered information is offered to the server 700 through the Internet 600. The requester information required by VDC requester information register page 900 may include the non-member's identification information, address, a wire telephone number, a mobile phone number and purpose of the VDC conference. The server 700 may store the entered requester information together with selected article information in the VDC requester DB 870. One example of VDC requester information page 1400 having VDC requester information stored in the VDC requester DB 870 is shown in FIG. 11.

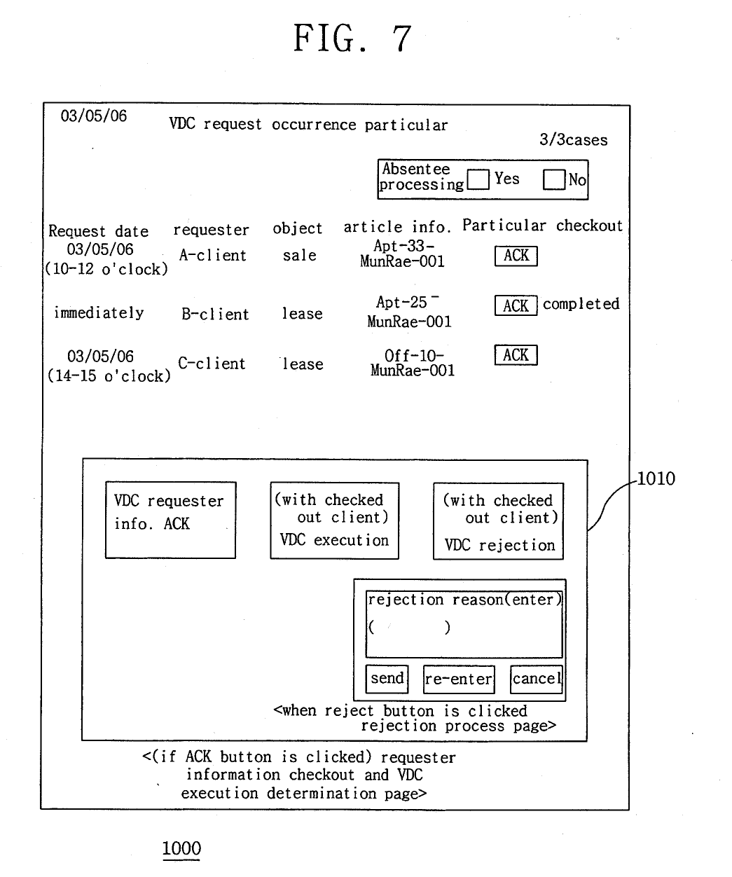

Meanwhile, the server 700 sets forth VDC requester occurrence particular page (hereinafter can be referred to as “particular page”) 1000 as shown in FIG. 7 based on the VDC requester information and the article information to thereby provide the generated particular page 1000 to one or more article registrant's (e.g., article registrants (300, 400: e.g., broker and construction company etc.) (i.e., registrant's corresponding terminal, hereinafter, it can have the same meaning) (at step S170).

In case that the article registrant (300, 400) acknowledges (i.e., checks out) the information indicated in the particular page 1000 and selects (clicks) ACK button included in the particular page 1000 (at step S180), the server 700 provides requester information acknowledgement (ACK) and VDC execution or non-execution determination page 1010 (hereinafter may be referred to as “determination page”) as shown in FIG. 7 having VDC requester information ACK and ACK execution or non-execution (VDC rejection) button, thereby providing the determination page 1010 to the article registrant (300, 400) (at step S190). The determination page 1010 is preferably displayed in an interior position of the VDC request occurrence particular page 1000.

If the article registrant (300, 400) selects a VDC requester information ACK button in the determination page 1010 (at step S191), in response to the ACK button selection, the server 700 provides the VDC requester information page 1400 having information about the VDC requester to the article registrant (300, 400) (at step S192).

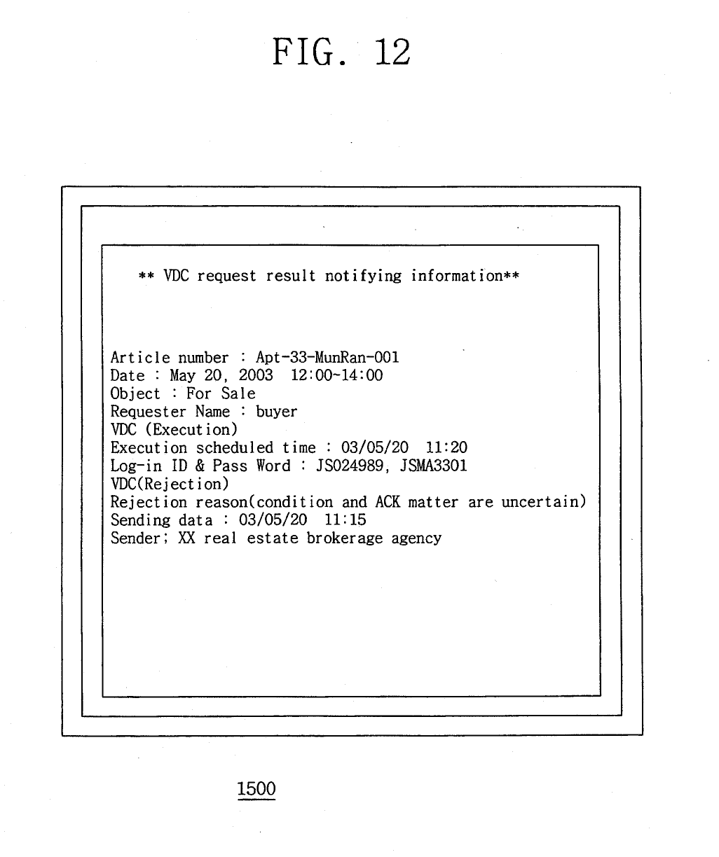

If the article registrant (300, 400) selects a VDC reject button included in the determination page 1010, the process advances from step S193 to step 5194 and the reject reason entry window within the determination page 1010 is activated by the server 700 (at step S194). And in case that a sending button in the reject reason entry window is selected after reject reason is entered into the reject reason entry window, the server 700 generates a VDC request result (notifying) page 1500 as shown in FIG. 12 corresponding to the reject reason and then provides the VDC request result page 1500 to the non-member's terminal 100 (at step S195).

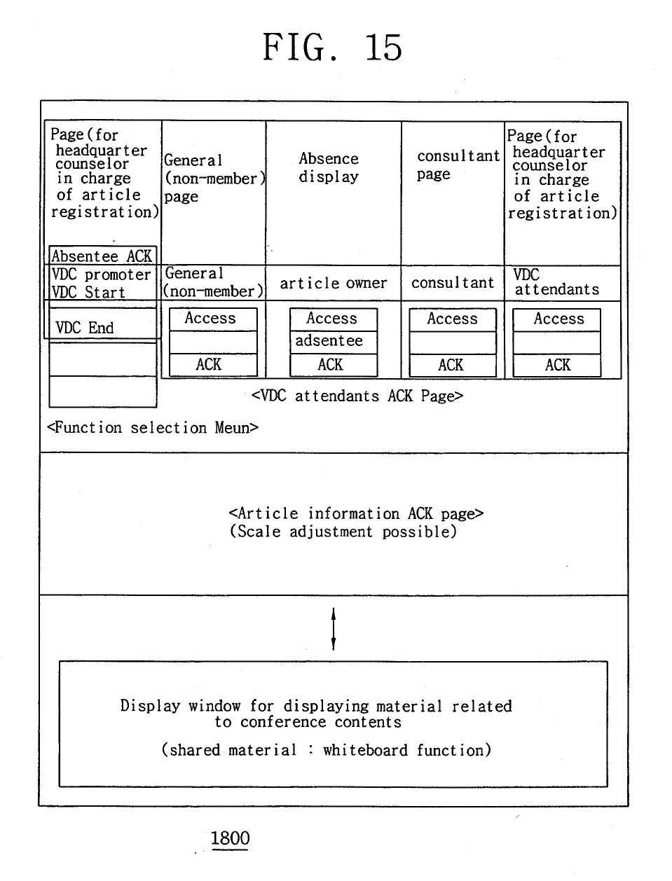

In addition, preferably, the server 700 generates the VDC request result page 1500 together with a corresponding message thereof and sends the generated message to the non-member's terminal 100 (e.g., non-member's telecommunication terminal (mobile phone, PDA etc.). Meanwhile, in the step 193, if the article registrant (300, 400) selects the VDC execution button included in the determination page 1010, the process advances to the step S196). At step S196, a VDC page 1800 as shown in FIG. 15 is generated (by the server 700) and then the VDC page 1800 is offered to the non-member 100 and the article registrant (300, 400), respectively. In accordance with another embodiment of the present invention, step S195 can be followed by step S197 which will be described hereinafter.

That is, if the article registrant (300, 400) selects the connecting (access) button at the below the non-member's window among the VDC attendants' windows of the VDC page 1800, the server 700 can provide the VDC request result notifying page 1500 to the VDC requester (i.e., the non-member 100). Further, the server 700 can generate the notifying page 1500 together with a message corresponding thereto, thereby sending the message and the notifying page 1500 to the general member 100 (e.g. a personal telecommunication terminal) (at step S197).

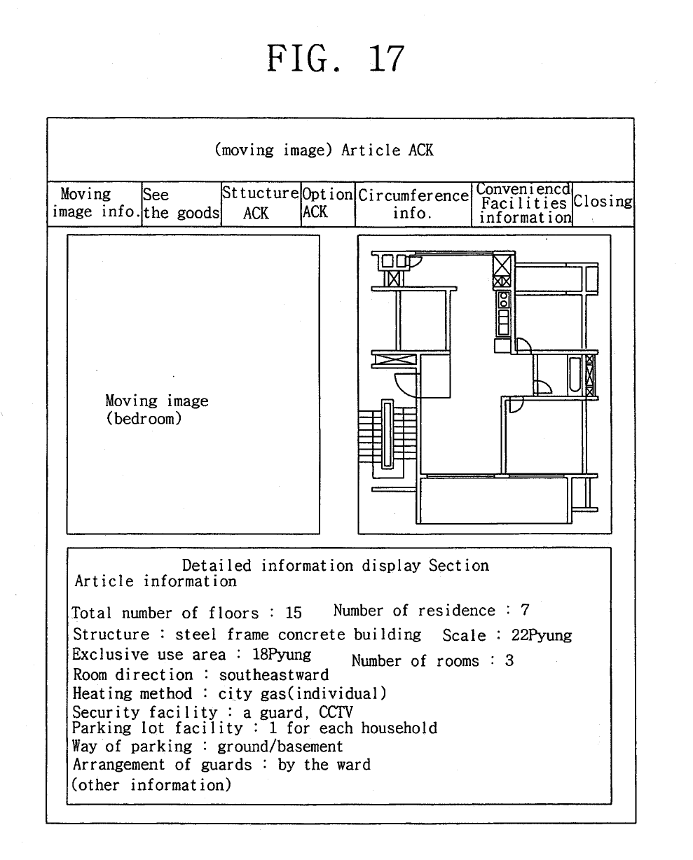

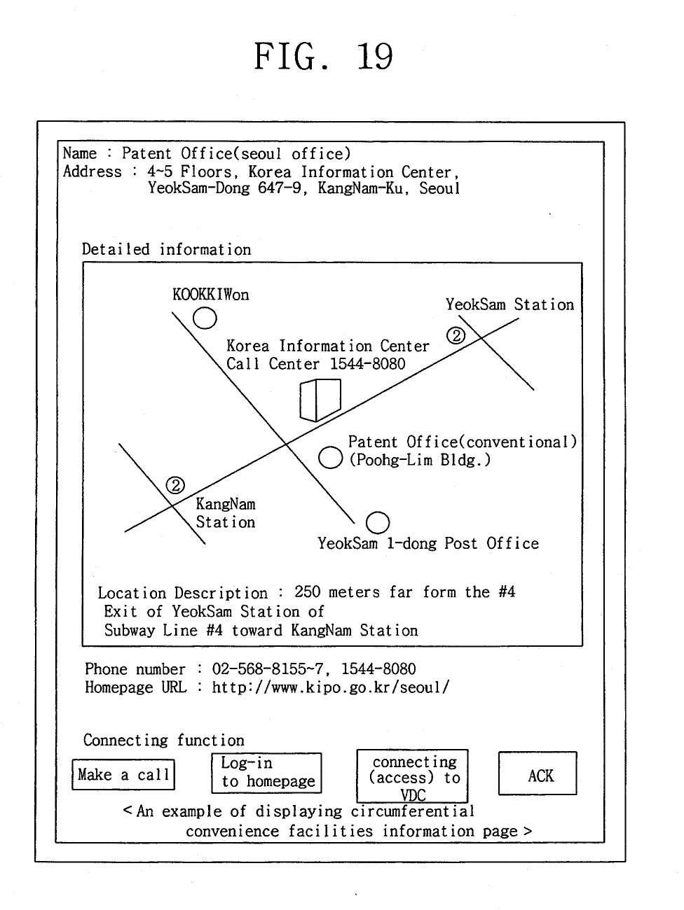

Meanwhile, the article registrant (300, 400) and the non-member 100 may check out (acknowledge) the article information as shown in FIG. 17, FIG. 18, and FIG. 19. In case that it is need to confirm (or acknowledge) the inquired matter (e.g., by the article registrant (300, 400)'s estimation), corresponding function buttons of the VDC page 1800 under use may be selected to thereby request VDC to the article owner 200 or the consultant 500. Consequently, the VDC in which the article registrant (300, 400), the non-member 100 and article owner 200 and/or consultant 500 participate may be held. The VDC attendants may exchange detailed information about the article through the VDC by using a VDC material indication display window in the VDC page 1800.

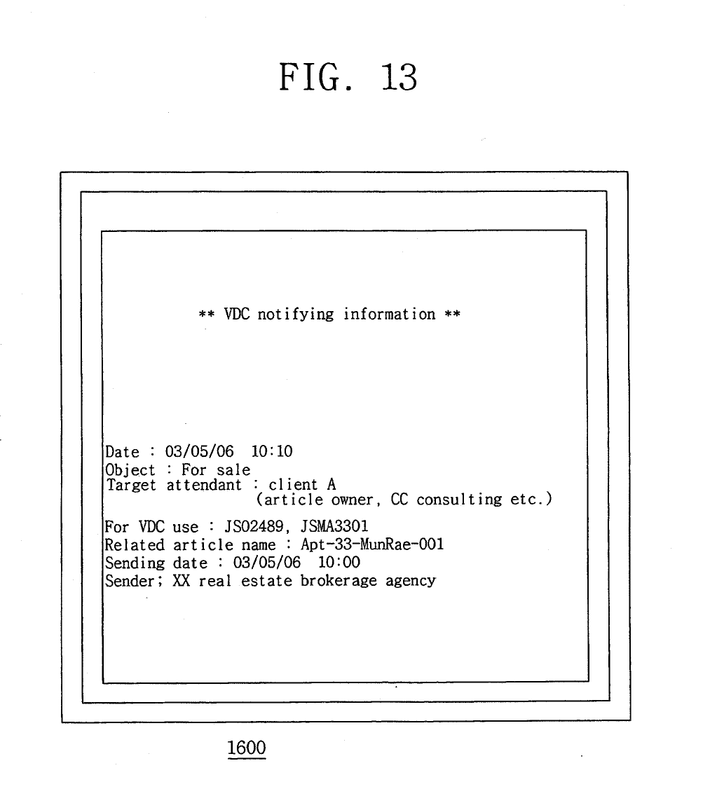

Herein, it should be noted that the server 700 may generate a VDC notifying information page 1600 (e.g. before a designated time of VDC) as shown in FIG. 13 by using the information for VDC stored in the article information DB 820 and the server 700 may also provide the page 1600 to VDC target attendants or send a corresponding (attendance notice) message to VDC target attendants through the mobile telecommunication network. Moreover, if an absentee (non-accessed one) occurs among the target attendants of the conference, a message indicating “absent” is displayed at the below the corresponding window of the VDC page 1800. When the VDC start button is clicked, the server 700 may generate information or data for the absentee based on the date and time, objective, attendants of the VDC and the host of the VDC and store the data in absentee information DB 830.

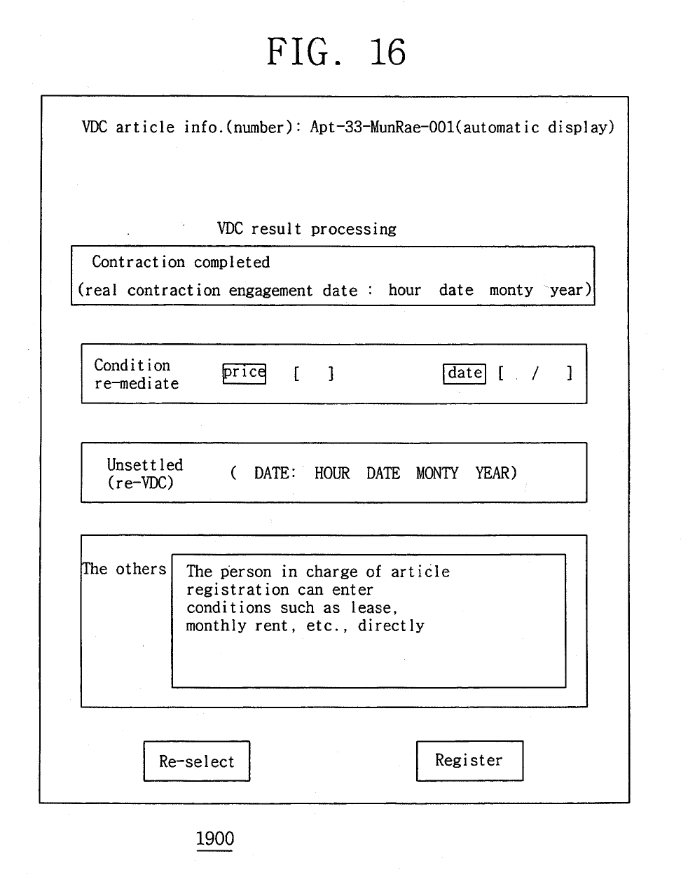

If the article registrant (300, 400) selects a VDC closing button in the VDC page 1800 to close VDC at step S198, the server 700 generates VDC result processing page 1900 as shown in FIG. 16, and provides it to the article registrant (300, 400) (at step S199). Subsequently, if the article registrant (300, 400) selects a VDC register button in the VDC result processing page 1900, the VDC is closed.

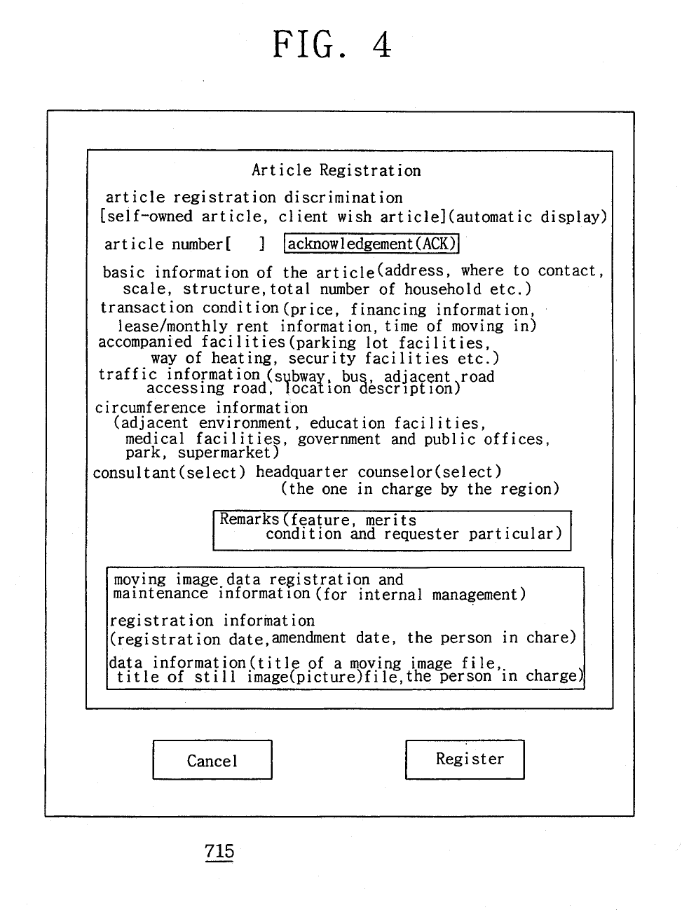

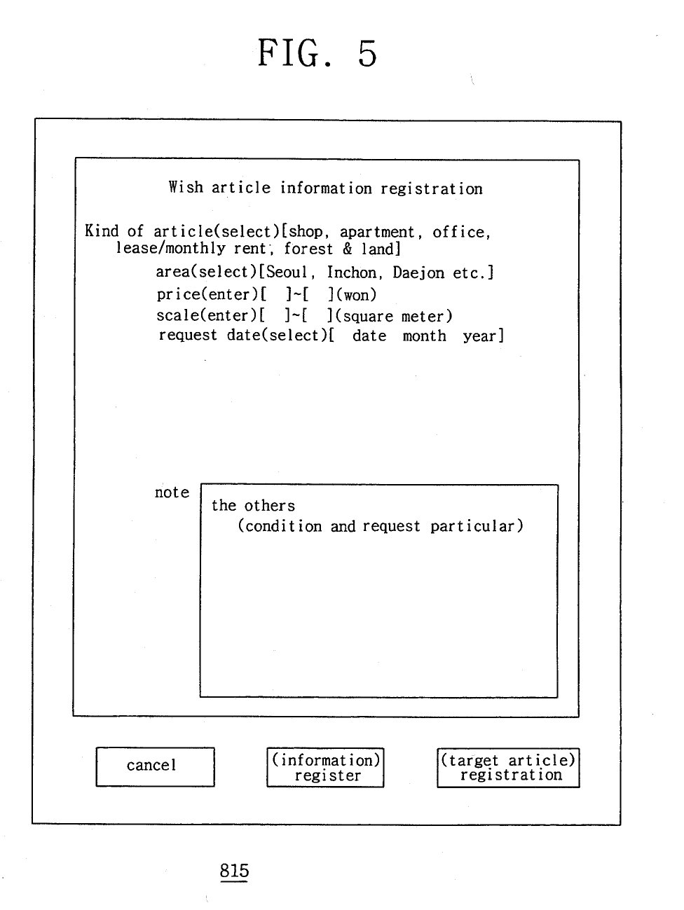

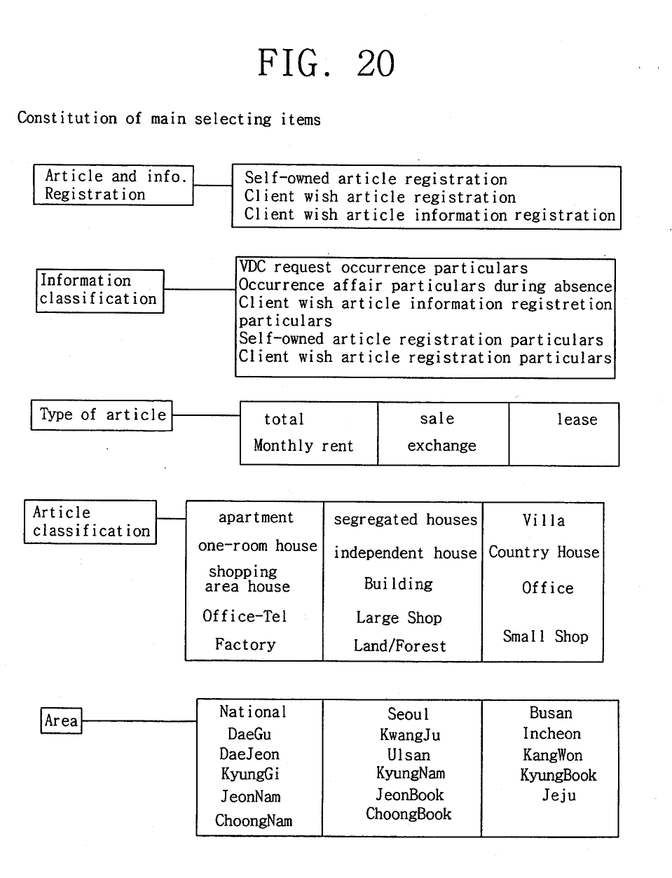

FIG. 4 shows an illustration of an example of an article register page 715 offered to the article registrant (300, 400) when registering an article in a real estate brokerage method through a VDC in accordance with a preferred embodiment of the present invention. Meanwhile, FIG. 5 is an illustration of an example of a wish article information register page 815 offered to the wish article registrant (300, 400) when registering a wish article in a real estate brokerage method through a VDC in accordance with another preferred embodiment of the present invention. FIG. 20 is an illustration of an example of selecting buttons linked to each selecting buttons included in the article search page 615 shown in FIG. 3.

Referring to FIG. 3, FIG. 4, FIG. 5 and FIG. 20, if the article registrant (300, 400) pushes (clicks) the article and information registration button in the article search page 615 shown in FIG. 3 in order to register an article or a client wish article, a self-owned article register button and a client wish article register button and a wish article information register button linked to the article and information register button are displayed. If the article registrant (300, 400) selects the article register button, the server 700 generates an article registration (register) page 715 as shown in FIG. 4 and provides it to the article registrant (300, 400). If the article registrant (300, 400) enters article information into the information entry window of the article registration page 715 and then selects the register button of the article registration page 715, the data entered into the article registration page 715 is sent to the server 700. Then, the server 700 registers the received article information into the article information DB 820.

Meanwhile, for example, if the article registrant (300, 400) selects a wish article registration button (not shown) (or selects once more the article and information registration button after selecting the article and information registration button) in the article search page 615 to register a wish article, the server 700 may generate the wish article registration (register) page 815 as illustrated in FIG. 5 and then provides it to the article register (300, 400). If the article registrant (300, 400) enters the wish article information into the wish article register page 815 and selects a registration button therein, the server 700 registers the wish article information into the client wish article (information) DB 860.

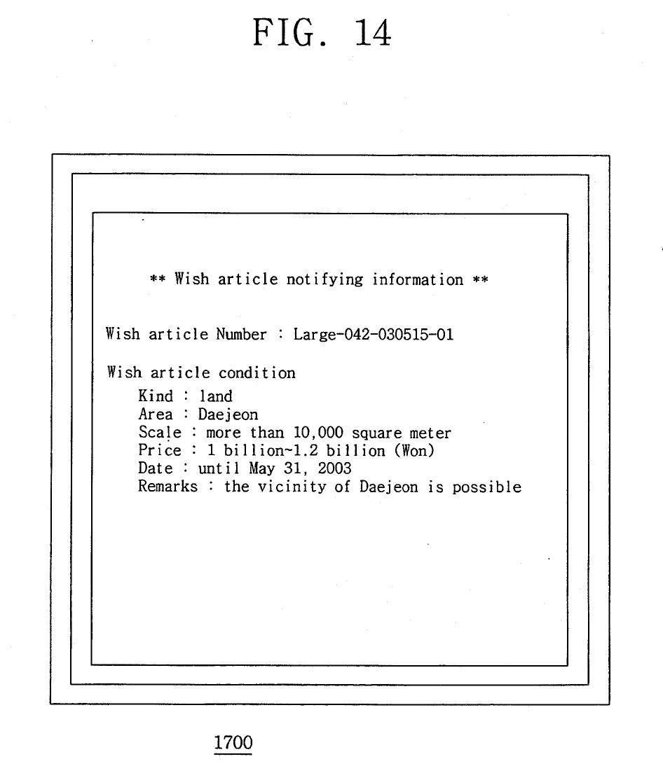

Further, the server 700 may generate a wish article notifying page 1700 as shown in FIG. 14 based on the wish article information stored in the client wish article DB 860 to thereby provide the page 1700 to the article registrant (e.g., 200, 300, 400) by E-mail or by letter message.

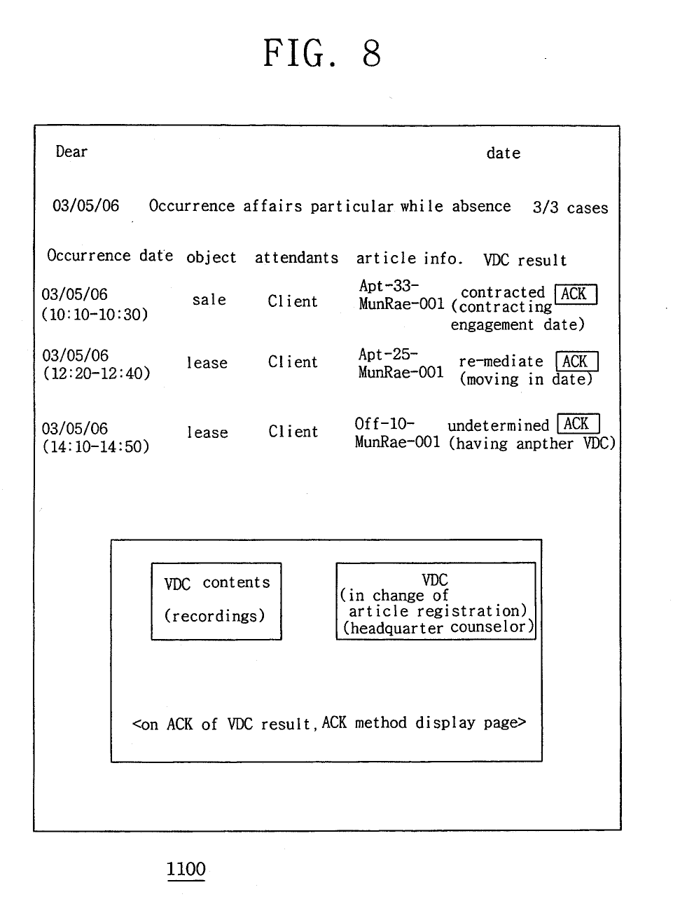

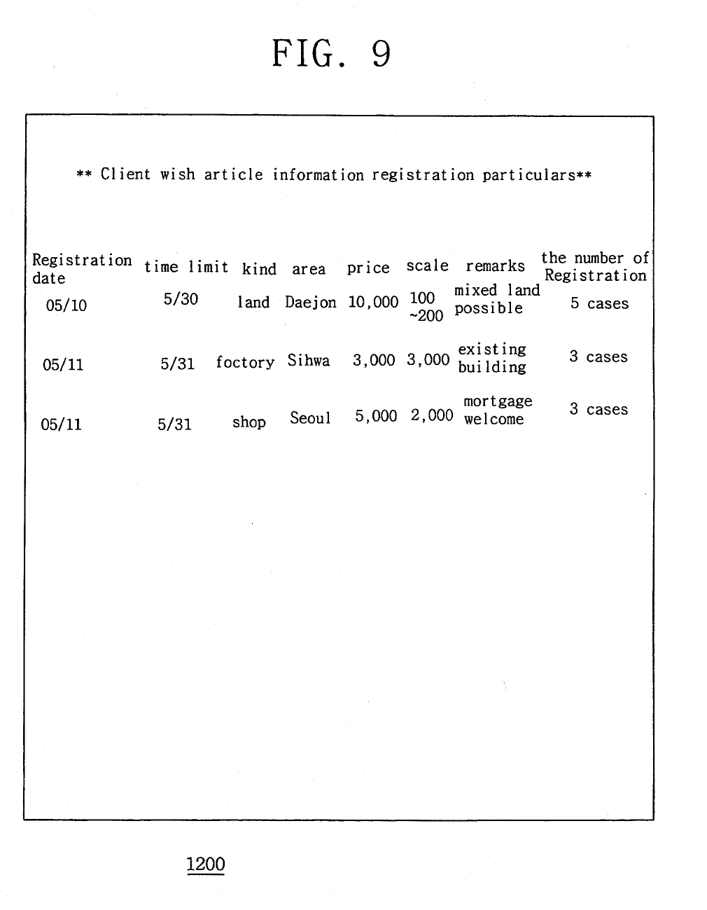

In accordance with other embodiments, in case of information dividing (or classifying) button indicated in search condition as shown in FIG. 3 is selected (clicked), a VDC request occurrence particular, an affair occurrence particular during absence, a wish article information register particular, a self-owned article register particular, a wish article register particular may be selected and checked out. Further, after entering necessary information into the other search condition, in case that the execution button is clicked, the server 700 can summarize the information corresponding to the entered condition from all sorts of DB's 800-870 and provide the necessary information to the member (200, 300, 400, 500) and/or non-member 100 by using pages illustrated in FIGS. 3 to 19.

Therefore, in accordance with preferred embodiments of the present invention, the buyer (purchaser) can easily get the information about a desired article and cut down the required expenses by checking out the article and by having VDC with an article registrant directly through the Internet.

While the present invention has been shown and described with respect to the preferred embodiments, it will be understood by those skilled in the art that various changes and modifications may be made without departing from the spirit and scope of the invention as defined in the following claims.

What is claimed is:

1. A real estate brokerage method through a video conference (VDC) for use in a real estate brokerage system connected to user's terminals through the Internet, the method comprising the steps of;
a) providing an article search page to a terminal of a non-member accessed to a corresponding Internet site through the Internet;
b) generating, in case that identification information of a user and search condition data are entered into a user data entry window and a search condition data entry window included in the article search page, respectively, an article describing page having information about an article satisfying the search condition to thereby provide the article describing page to the non-member's terminal;
c) producing, in case that a VDC request button included in the article describing page is clicked through the non-member's terminal, VDC requester information register page (hereinafter referred to as “register page”) to thereby provide the register page to the non-member's terminal;
d) generating, in case that VDC requester information is entered into requester information entry window included in the register page through the non-member's terminal, VDC request occurrence particular page (hereinafter referred to as “particular page”) based on the VDC requester information and the article information to thereby provide the particular page to an article registrant's terminal;
e) providing, in case that an acknowledgment (ACK) button included in the particular page is clicked through the article registrant's terminal, a VDC requester information acknowledgement (ACK) and VDC execution or non-execution determination page (hereinafter referred to as “determination page”) to the article registrant's terminal;
f) offering, in case that a VDC requester information ACK button included in the determination page is clicked through the article registrant's terminal, a VDC requester information page having information about the VDC requester to the article registrant's terminal; and
g) generating, in case that a VDC closing button is selected through the article registrant's terminal, VDC result processing page to thereby provide the VDC result processing page to the article registrant's terminal.

2. The method of claim 1, further comprising the steps of:
h) activating, in case that a VDC reject button included in the determination page is selected through the article registrant's terminal, a reject reason entry window in a preset position within the determination page; and
i) providing, in case that a sending button of the reject reason entry window is selected after reject reason is entered into the reject reason entry window thereof through the article registrant's terminal, a VDC request result page to the non-member's terminal.

3. The method of claim 1, wherein the search condition data has at least one of kind, area, price and scale of the article.

4. The method of 1, wherein the article describing page includes either moving picture information or article information for each of one or more articles.

5. The method of claim 1, wherein the article search page further includes an article register button and the method further comprises the steps of:
j) providing the article search page to the article registrant's terminal through the Internet;
k) offering, in case that the article register button is selected in the article search page through the article registrant's terminal, an article register page to the article registrant's terminal; and
l) registering, in case that article information is entered into through information entry window included in the article register page and then a register button included in the article register page is selected through the article registrant's terminal, the article information inputted thereto through the article register page into an article information database.

6. The method of claim 1, wherein the article search page further includes a wish article register button and the method further comprises the steps of:
j1) providing the article search page to the article registrant's terminal through the Internet;
k1) offering, in case that the wish article register button is selected in the article search page through the article registrant's terminal, a wish article register page to the article registrant's terminal; and
l1) registering, in case that article information is entered into through information entry window included in the wish article register page and then a register button included in the wish article register page is selected through the article registrant's terminal, the wish article information inputted thereto through the wish article register page into a wish article information database.

7. The method of claim 2, further comprising the step of:
m) generating a message corresponding to the VDC request result page and then sending the generated message to a non-member's communication terminal.
